(19) United States
(12) Patent Application Publication
(10) Pub. No.: US 2024/0308408 A1
(43) Pub. Date: Sep. 19, 2024

(54) Retractable Truck Bed Lift

(71) Applicants: Rollin Anthony Tobie, Port Orange, FL (US); Lacey Jean Tobie, Port Orange, FL (US)

(72) Inventors: Rollin Anthony Tobie, Port Orange, FL (US); Lacey Jean Tobie, Port Orange, FL (US)

(21) Appl. No.: 18/603,432

(22) Filed: Mar. 13, 2024

Related U.S. Application Data
(60) Provisional application No. 63/451,754, filed on Mar. 13, 2023.

(51) Int. Cl. B60P 1/54; B60Q 1/24

(52) U.S. Cl. CPC B60P 1/5433; B60Q 1/24

(57) ABSTRACT

A lift for a truck bed comprises a base configured to mount to the truck bed. A mast is coupled to the base. The mast extends along a first axis transverse to the truck bed. A first actuator is configured to expand and retract the mast along the first axis. A boom is coupled to the mast. The boom extends along a second axis transverse to the first axis.

### CROSS REFERENCE TO RELATED APPLICATIONS

This application is based upon and claims priority to U.S. Provisional Application No. U.S. 63/451,754, filed Mar. 13, 2023, which application is hereby incorporated by reference herein.

### FIELD OF THE INVENTION

This invention relates to truck bed lifts, in particular, retractable lifts that may be stowed in truck beds.

### BACKGROUND

A truck bed lift may be necessary to lift heavy apparatuses onto the bed of the truck. Lifts that mount to the truck hitch are heavy and cumbersome to install and remove. In-bed lifts extend beyond the edge of the bed and therefore renders a truck bed cover unusable. A lift that can retract to stow away within the bed of the truck under a truck bed cover is desirable to protect and secure the lift. There is clearly an opportunity to improve truck bed lifts to allow the lift to be stowed and covered within the bed of the truck without disassembly.

### SUMMARY

Disclosed herein is a lift for a truck bed. The lift comprises a base configured to mount to the truck bed. A mast is coupled to the base. The mast extends along a first axis transverse to the truck bed. A first actuator is configured to expand and retract the mast along the first axis. A boom is coupled to the mast. The boom extends along a second axis transverse to the first axis.

In some aspects, the lift further comprises a second actuator configured to expand and retract the boom.

According to some embodiments, the lift further comprises a third actuator configured to rotate the mast about the first axis.

In exemplary aspects, the lift further comprises a fourth actuator configured to pivot the boom about the first axis.

In exemplary embodiments, the lift further comprises a hoist coupled to a proximate end of the boom and extending along a third axis parallel to the first axis.

In various aspects, the lift further comprises a fifth actuator configured to expand and retract the hoist.

In some aspects, the lift further comprises a light coupled to the boom.

In exemplary embodiments, the base includes a first leg and a second leg.

In some further embodiments, the first leg and the second leg are configured to fasten to the truck bed.

In some examples, the lift is configured to electrically connect to a truck.

In exemplary embodiments, the lift further comprises a power inverter and an outlet.

In some aspects, the mast is configured to retract below a top edge of the truck bed.

According to some embodiments, the lift further comprises a controller.

Also disclosed is a method comprising expanding a mast of a lift coupled to a truck bed by a first actuator coupled to the mast. The method further comprises retracting the mast of the lift by the first actuator.

In exemplary aspects, the method further comprises rotating the mast by a third actuator.

In exemplary embodiments, the method further comprises expanding a boom of the lift by a second actuator coupled to the boom, and retracting the boom of the lift by the second actuator.

In some further examples, the method comprises rotating the boom of the lift by a fourth actuator.

In various aspects, the method further comprises expanding a hoist of the lift by a fifth actuator, and retracting the hoist by the fifth actuator.

In other aspects, the method further comprises lifting an object onto the truck bed with the lift.

In exemplary embodiments, the first actuator is configured to retract the mast below a top edge of the truck bed.

### BRIEF DESCRIPTION OF THE DRAWINGS

FIG. 1 is a perspective view of an example lift according to the invention;

FIG. 2 is a side view of the example lift of FIG. 1;

FIG. 3 is a top view of the example lift of FIG. 1;

FIG. 4 is a section view of the example lift of FIG. 1 with the mast retracted;

FIG. 5 is a block diagram of an example operating environment comprising a computing device as disclosed herein for controlling the example lift;

FIG. 6A is a block diagram of an example first actuator as disclosed herein;

FIG. 6B is a block diagram of an example second actuator as disclosed herein;

FIG. 6C is a block diagram of an example third actuator as disclosed herein;

FIG. 6D is a block diagram of an example fourth actuator as disclosed herein; and

FIG. 6E is a block diagram of an example fifth actuator as disclosed herein.

### DETAILED DESCRIPTION

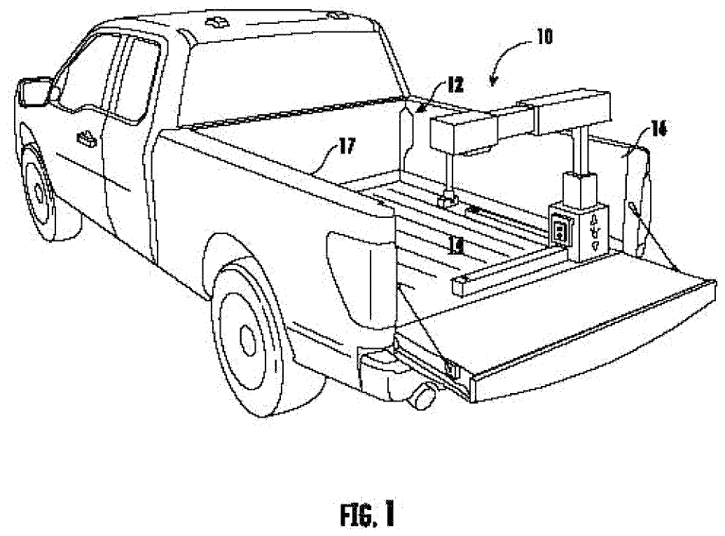

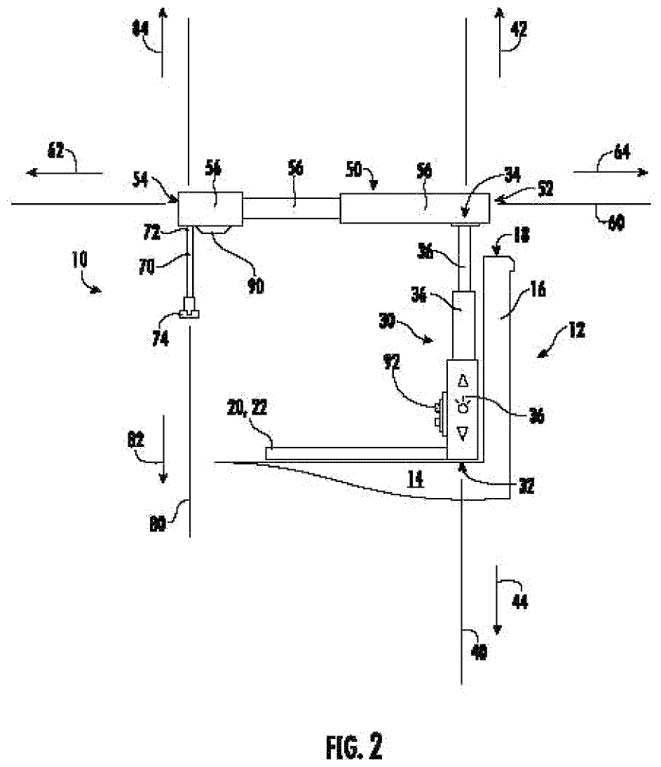

FIG. 1 shows a lift 10 for a truck bed 12. The truck bed 12 includes a floor 14 and a first side 16. The truck bed 12 includes a second side 17 oppositely disposed from the first side 16. As shown in FIG. 2, the sides 16, 17 (the first side 16 shown) include a top edge 18. The lift 10 may be used to move heavy objects into the truck bed 12. In one example, the lift 10 may be used to move scooters, ATVs, or motorcycles.

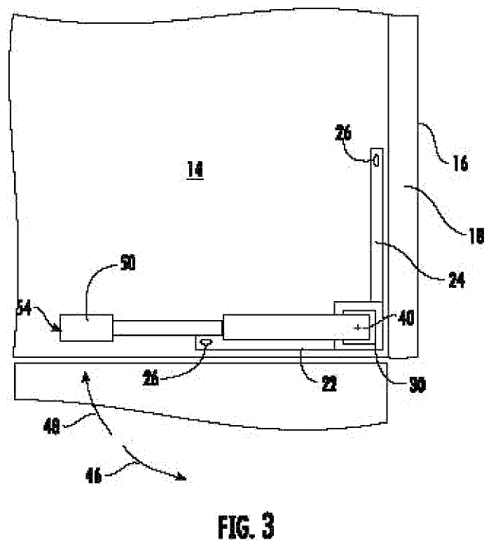

As shown in FIG. 2, the lift 10 includes a base 20 configured to connect or couple to the truck bed 12 to secure and stabilize the lift 10. In this example, the base 20 is connected or coupled to the floor 14 of the truck bed 12. Alternatively or in addition, the base 20 may be connected or coupled to the side 16 of the truck bed 12. As shown in FIG. 3, the base 20 may include a first leg 22 and a second leg 24 positioned at or approximately positioned (for example, within 10 degrees) at a 90 degree angle. The first and second legs 22, 24 may include connection points 26 to connect or couple the legs 22, 24 to the truck bed 12. Although one connection point 26 is shown for each leg 22, 24, there may be more than one connection point 26 for each leg 22, 24. In one example, the connection points 26 may be fasteners connected to the floor 14 of the truck bed 12.

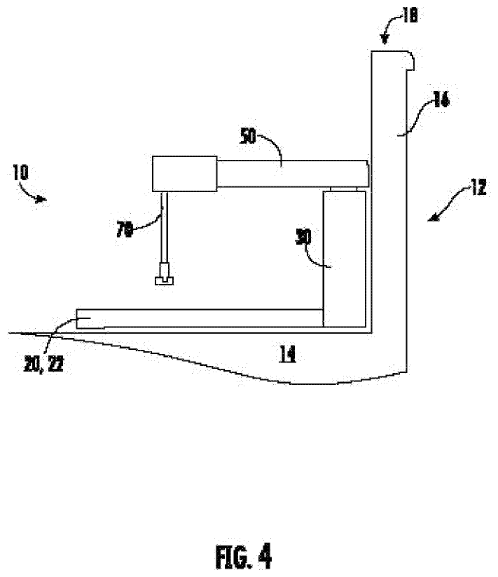

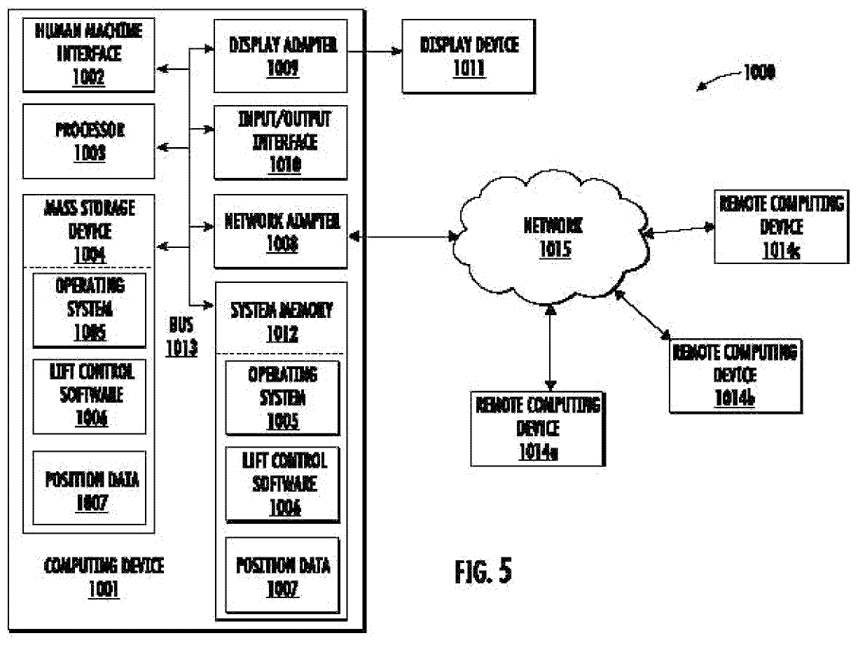

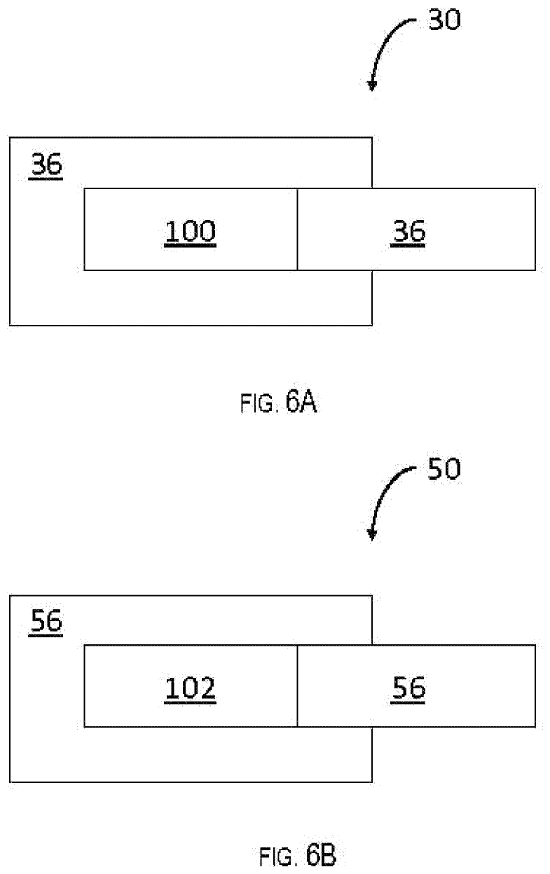

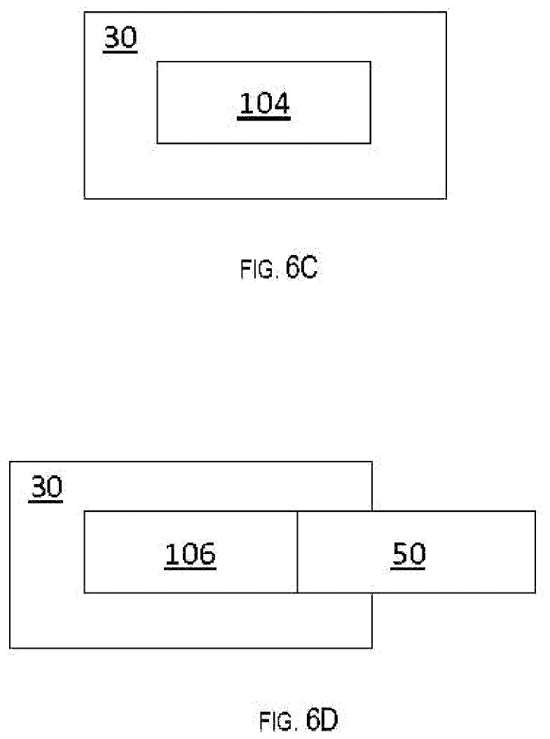

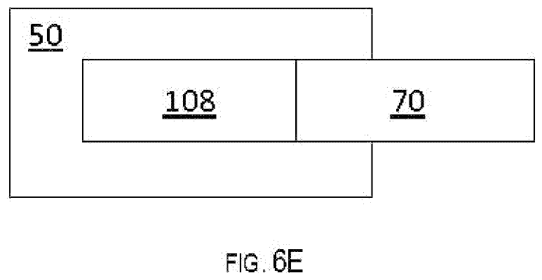

With reference to FIG. 2, the lift 10 includes a mast 30 extending along a first axis 40. This mast 30 is connected or coupled to the base 20. In this example, the mast 30 is connected or coupled to the base 20 at or proximate to a first end 32. A first actuator 100 (shown in FIG. 6A) connected or coupled to the mast 30 is configured to expand and retract the mast 30 along the first axis 40. The first actuator 100 may be any suitable actuator known in the art including but not limited to pneumatic, hydraulic, or electric actuators. In this example, a second end 34 of the mast 30 oppositely disposed from the first end 32 may be configured to move in a first direction 42 away from the floor 14 of the truck bed 12 to expand the mast 30 and move in a second direction 44 toward the floor 14 of the truck bed 12 to retract the mast 30. As shown in FIG. 2, the mast 30 may include a plurality of telescoping sections 36 to allow expansion and retraction of the mast 30. A user of the lift 10 may expand the mast 30 to a use position wherein the mast 30 is fully expanded as shown in FIG. 2. In this position, the second end 34 of the mast 30 may extend beyond the top edge 18 of the side 16 of the truck bed 12. The user of the lift 10 may retract the mast 30 to a stowed position wherein the mast 30 is fully retracted as shown in FIG. 4. In this position, the top of the lift 10 is retracted below the top edge 18 of the side 16 of the truck bed 12 thereby allowing the lift 10 to be secured and protected under a truck bed cover. The lift 10 may be protected from the environment when not in use without being disassembled.

The lift 10 further includes a boom 50 connected or coupled to the mast 30. The boom 50 may be connected or coupled to the mast 30 at or proximate to a first end 52. The boom 50 extends along a second axis 60 transverse to the first axis 40. A second actuator 102 (shown in FIG. 6B) may be connected or coupled to the boom 50. The second actuator 102 may be any suitable actuator known in the art including but not limited to pneumatic, hydraulic, or electric actuators. The second actuator 102 may be configured to expand and retract the boom 50 along the second axis 60. In this example, a second end 54 of the boom 50 oppositely disposed from the first end 52 may be configured to move in a first direction 62 away from the mast 30 to expand the boom 50 and move in a second direction 64 toward the mast 30 to retract the boom 50. As shown in FIGS. 2 and 3, the boom 50 may include a plurality of telescoping sections 56 to allow expansion and retraction of the boom 50. A user of the lift 10 may expand the boom 50 to a use position wherein the boom 50 is fully expanded as shown in FIG. 2. The user of the lift 10 may retract the boom 50 to a stowed position wherein the boom 50 is fully retracted as shown in FIG. 3. In the stowed position, the lift 10 is more compact to allow for more space in the truck bed 12.

The lift 10 may include may include a third actuator 104 (shown in FIG. 6C) configured to rotate the mast 30 about the first axis 40. The third actuator may be any suitable actuator known in the art including but not limited to pneumatic, hydraulic, or electric actuators. As the mast 30 rotates, the boom 50 pivots wherein the second end 54 of the boom 50 moves in a first direction 46 away from the truck bed 12 or a second direction 48 towards the truck bed 12 to allow a hoist 70 connected or coupled to the boom 50 (shown in FIG. 4) access to move an object onto or off of the truck bed 12. Alternatively or in addition, the lift 10 may include a fourth actuator 106 (shown in FIG. 6D) configured to pivot the boom 50 about the first axis 40. The fourth actuator 106 may be any suitable actuator known in the art including but not limited to pneumatic, hydraulic, or electric actuators. In this embodiment, the mast 30 may remain stationary while the boom 50 pivots to move the second end 54 of the boom 50 in the first direction 46 or the second direction 48.

As shown in FIG. 2, the hoist 70 extends along a third axis 80 parallel or substantially parallel to the first axis 40. A first end 72 of the hoist 70 may be connected or coupled at or proximate to the second end 54 of the boom 50. The second end 74 of the hoist 70 may be configured to directly or indirectly couple to an object to be lifted to or from the truck bed 12. The lift 10 may further comprise a fifth actuator 108 (shown in FIG. 6E) configured to expand and retract the hoist 70 to allow the object to be lifted or lowered. The fifth actuator may be any suitable actuator known in the art including but not limited to pneumatic, hydraulic, or electric actuators. For example, the hoist 70 may expand in a first direction 82 along the third axis 80 to allow the object to reach ground level and retract in a second direction 84 along the third axis 80 to allow the object to reach the floor 14 of the truck bed 12. The lift 10 may further include a light 90 to illuminate at least the hoist 70 to allow a user to more easily connect or couple the hoist 70 to the object at night or in dim lit areas.

The lift 10 may be configured to electrically connect to the truck thereby allowing at least one of the first actuator, second actuator, third actuator, fourth actuator and fifth actuator to be electrically controlled. In one embodiment, the lift 10 may include a power inverter and an outlet 92 to allow a user to charge an object (such as a scooter, ATV or motorcycle).

The lift 10 can comprise at least one computing device for controlling operation of the lift. For example, one or more computing devices can control a plurality of operations, including control of at least one of the first, second, third, fourth, and fifth actuator. In some optional aspects, a single computing device controls a plurality of such operations. In some aspects, the lift 10 can comprise a plurality of computing devices that operate in coordination. For example, a first computing device (e.g., a controller) can control the first actuator, and a second computing device can control the second actuator. Still another computing device can provide an operator with an interface at a human machine interface for permitting the operator to control aspects of the lift. Each of said computing devices can optionally be embodied in accordance with the computing device 1001 as further disclosed herein.

FIG. 5 shows an exemplary operating environment 1000 including an exemplary configuration of a computing device 1001 for use with the lift 10 disclosed herein.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as position data 1007 and/or program modules such as operating system 1005 and lift control software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and lift control software 1006 may be stored on the mass storage device 1004. One or more of the operating system 1005 and lift control software 1006 (or some combination thereof) may comprise program modules and the lift control software 1006. The position data 1007 may also be stored on the mass storage device 1004. The position data 1007 may be stored in any of one or more databases known in the art. The databases may be centralized or distributed across multiple locations within the network 1015.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The remote computing devices 1014a,b,c, can perform respective operations of the system. For example, one remote computing device 1014a can be a controller of the first actuator. One remote computing device 1014b can be a controller of the second actuator. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

It is expected that the example lift 10, including at least a retractable mast 30, according to the invention will allow a user to stow the lift within a truck bed without disassembly.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A lift for a truck bed, the lift comprising:
a base configured to mount to the truck bed;
a mast coupled to the base and extending along a first axis transverse to the truck bed;
a first actuator configured to expand and retract the mast along the first axis; and
a boom coupled to the mast and extending along a second axis transverse to the first axis.

2. The lift according to claim 1 further comprising a second actuator configured to expand and retract the boom.

3. The lift according to claim 1 further comprising a third actuator configured to rotate the mast about the first axis.

4. The lift according to claim 1 further comprising a fourth actuator configured to pivot the boom about the first axis.

5. The lift according to claim 1 further comprising a hoist coupled to a proximate end of the boom and extending along a third axis parallel to the first axis.

6. The lift according to claim 5 further comprising a fifth actuator configured to expand and retract the hoist.

7. The lift according to claim 1 further including a light coupled to the boom.

8. The lift according to claim 1, wherein the base includes a first leg and a second leg.

9. The lift according to claim 8, wherein the first leg and the second leg are configured to fasten to the truck bed.

10. The lift according to claim 1, wherein the lift is configured to electrically connect to a truck.

11. The lift according to claim 1 further comprising a power inverter and an outlet.

12. The lift according to claim 1, wherein the mast is configured to retract below a top edge of the truck bed.

13. The lift according to claim 1 further comprising a controller.

14. A method comprising:
expanding a mast of a lift coupled to a truck bed by a first actuator coupled to the mast; and
retracting the mast of the lift by the first actuator.

15. The method according to claim 14 further comprising rotating the mast by a third actuator.

16. The method according to claim 14 further comprising expanding a boom of the lift by a second actuator coupled to the boom, and retracting the boom of the lift by the second actuator.

17. The method according to claim 16 further comprising rotating the boom of the lift by a fourth actuator.

18. The method according to claim 14 further comprising expanding a hoist of the lift by a fifth actuator, and retracting the hoist by the fifth actuator.

19. The method according to claim 14 further comprising lifting an object onto the truck bed with the lift.

20. The method according to claim 14, wherein the first actuator is configured to retract the mast below a top edge of the truck bed.
